(19) United States
(12) Patent Application Publication
(10) Pub. No.: US 2013/0047118 A1
(43) Pub. Date: Feb. 21, 2013

(54) METHOD FOR MANAGING NON-OVERLAPPING WINDOWS

(71) Applicants: Dean Hooper, Oak Grove, MN (US); Christine Ford, Maplewood, MN (US); Sheryl LeDuc, Gold Canyon, AZ (US)

(72) Inventors: Dean Hooper, Oak Grove, MN (US); Christine Ford, Maplewood, MN (US); Sheryl LeDuc, Gold Canyon, AZ (US)

(21) Appl. No.: 13/592,896

(22) Filed: Aug. 23, 2012

Related U.S. Application Data
(63) Continuation of application No. PCT/US2011/027470, filed on Mar. 8, 2011.
(60) Provisional application No. 61/311,510, filed on Mar. 8, 2010.

(51) Int. Cl. G06F 3/048

(52) U.S. Cl. 715/790

(57) ABSTRACT

A method of editing a graphical user interface is disclosed. The method includes detecting a user command to adjust a first window to at least partially overlap with a second window, modifying the second window to prevent the overlap, and adjusting the first window as directed by the user command.

### CROSS REFERENCE TO RELATED APPLICATIONS

This application is a continuation of PCT/US2011/027470, filed Mar. 8, 2011, which claims benefit of U.S. Provisional Application No. 61/311,510, filed on Mar. 8, 2010, the entire disclosures of both are incorporated herein by reference.

### FIELD

The present disclosure relates to methods for managing non-overlapping objects in a windows-like environment.

### BACKGROUND

This section provides background information related to the present disclosure which is not necessarily prior art.

Graphical user interfaces may contain one or more windows. Windows may enable a user to view data, control software, etc. Users may edit the graphical user interface by moving and resizing windows. Such editing can become tedious when the interface includes multiple windows.

Some graphical user interfaces prevent some windows from overlapping. For example, a medical system may contain several patient status windows that cannot overlap. Further, it is difficult to communicate window overlapping restrictions to the user. Users who are accustomed to overlapping windows may become confused or frustrated when they are unable to overlap windows and must manually move each window to avoid overlap.

### SUMMARY

This section provides a general summary of the disclosure, and is not a comprehensive disclosure of its full scope or all of its features.

According to one aspect of the present disclosure, a method of editing a graphical user interface is disclosed. The method includes detecting a user command to adjust a first window to at least partially overlap with a second window, modifying the second window to prevent the overlap, and adjusting the first window as directed by the user command.

According to another aspect of the present disclosure, an apparatus includes a display and a controller configured to edit a graphical user interface shown on the display. The controller is configured to: detecting a user command to adjust a first window to at least partially overlap with a second window, modifying the second window to prevent the overlap, and adjusting the first window as directed by the user command.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram according to one example embodiment of the present disclosure.

FIGS. 2-15 are illustrations of windows according to example embodiments of the present disclosure.

FIG. 16 is a block diagram of an apparatus according to another example embodiment of the present disclosure.

FIGS. 17-21 are illustrations of windows according to example embodiments of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

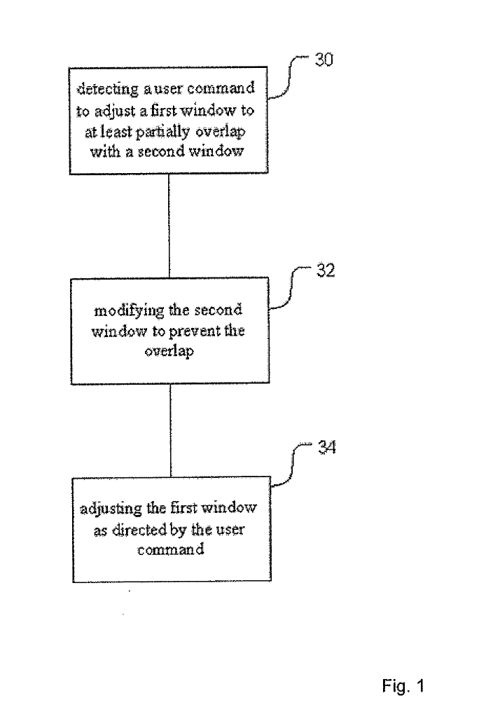

FIG. 1 shows a method of editing a graphical user interface. The method comprises detecting a user command to adjust a first window to at least partially overlap with a second window 30, modifying the second window to prevent the overlap 32, and adjusting the first window as directed by the user command 34.

The windows may be graphical objects displayed on a graphical workspace. The windows may be, for example, rectangular, square, oval, etc. The windows may include graphical control features such as, for example, toolbars, menus, buttons, etc. The windows may be control windows which contain control features. Also, the windows may be display windows which display data, videos, etc. The windows may be represented in two dimensions or in three dimensions.

This method automates the process of managing non-overlapping windows. Thus, the tedium and confusion experienced by the user is reduced.

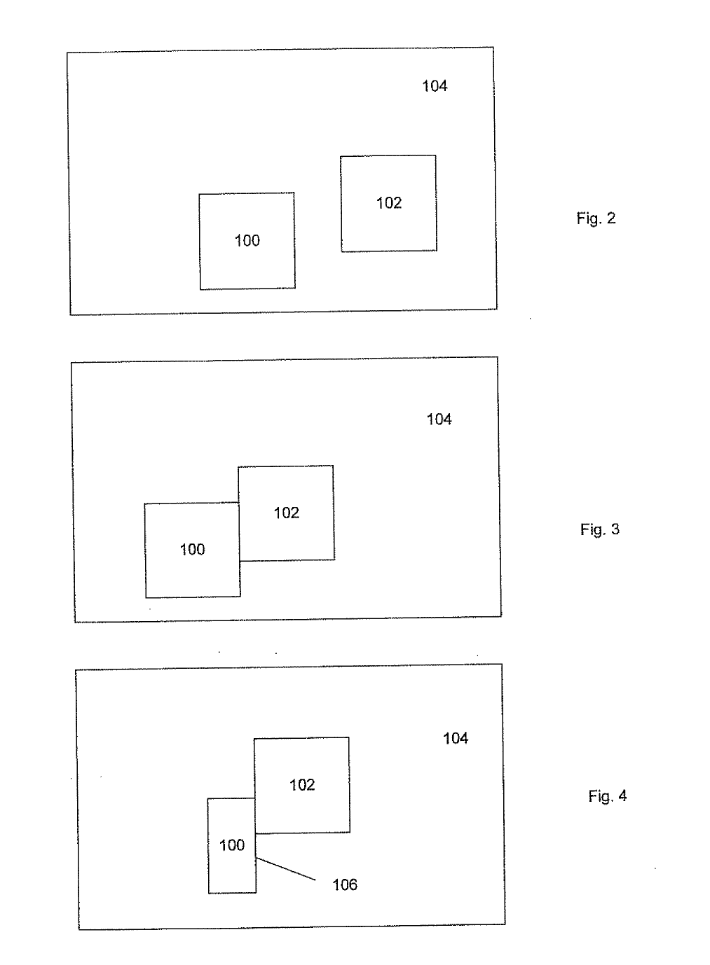

FIG. 2 shows window 100 and window 102 displayed on a display area 104. The boundaries of display area 104 may correspond to the displayable area of a physical screen. The boundaries of display area 104 may also correspond to a region of the displayable area of a physical screen.

FIG. 3 shows an example of the windows after a user generates a user command to move window 102 to the left. Window 100 was moved to the left so that the windows do not overlap.

FIG. 4 shows another example of the windows after a user generates a user command to move window 102 to the left. Window 100 was shrunk by moving a border 106 away from window 102 so that the windows do not overlap.

The method is not limited to user commands to move a window. For example, the user command may be to move a group of windows. Also, the user command may be to resize one or more windows.

The user may initiate user commands by clicking on a window and dragging it with a mouse. User commands may be initiated in other ways, for example, by typing on a keyboard or by activating other user interface devices.

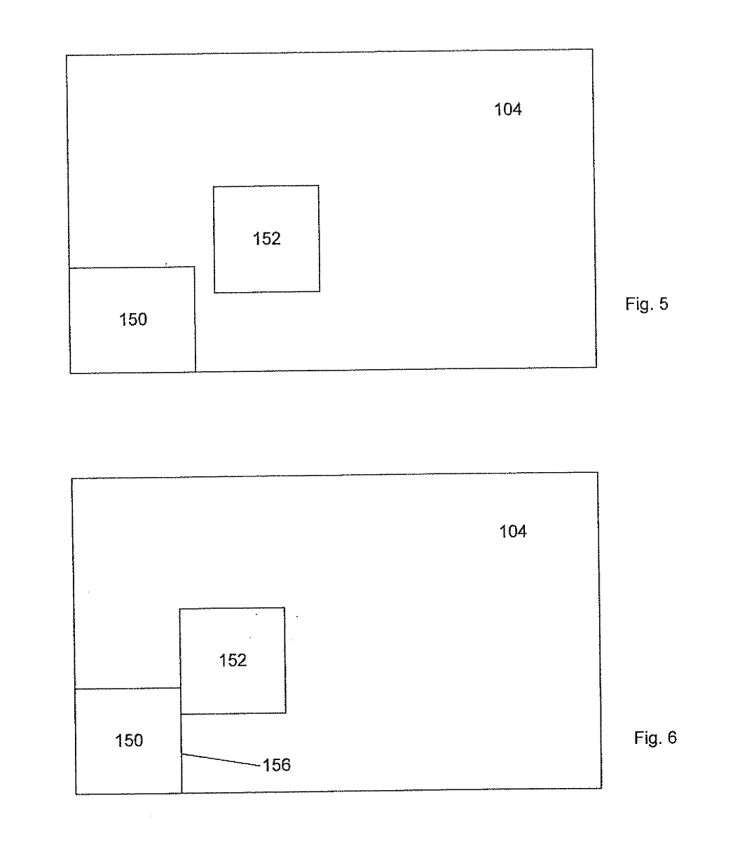

FIG. 5 shows window 150 and window 152 displayed on the display area 104. Window 150 is constrained by the boundaries of the display area 104 and cannot be moved left or down. FIG. 6 shows an example of the windows after a user generates a command to move window 152 to the left. Instead of moving window 150 away from window 152, window 150 was shrunk by moving a boundary 156 away from window 152. This prevents overlapping of the windows.

The boundaries of the display area 104 are not the only possible constraints. Some types of windows, for example control windows, may be confined to a sub-area of the display area 104. The edges of such a sub-area may also create constraints.

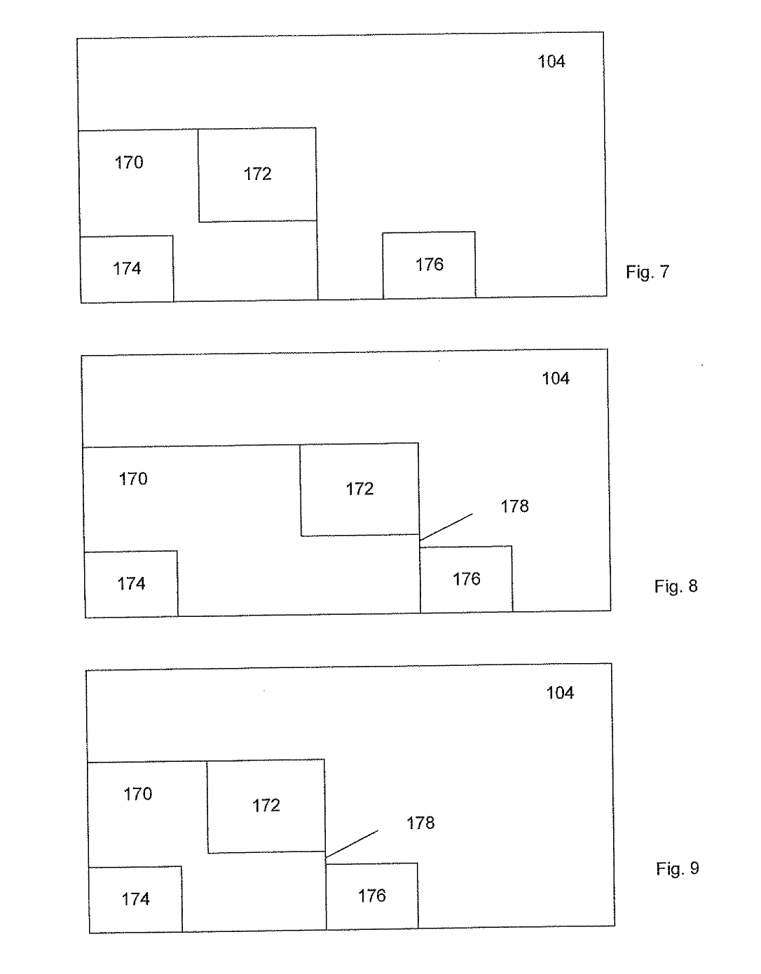

FIG. 7 shows window 170 that encompasses sub-window 172 and sub-window 174. Window 176 is not a sub-window of window 170. FIG. 8 shows an example of the windows after a user generates a command to move sub-window 172 to the right. Window 170 was expanded by moving a boundary 178 such that window 170 continues to encompass sub-window 172. Window 176 was moved to the right so that window 170 and window 176 do not overlap.

Sub-window 172 and sub-window 174 may be, for example, control windows. Window 170 may encompass all control windows located on the display area 104. In this way the control windows are conveniently grouped and are easily discernable.

FIG. 9 shows an example of the windows after a user generates a command to move window 176 to the left. Window 170 was shrunk by moving the boundary 178 away from window 176. Sub-window 172 was moved to the left such that window 170 continues to encompass sub-window 172.

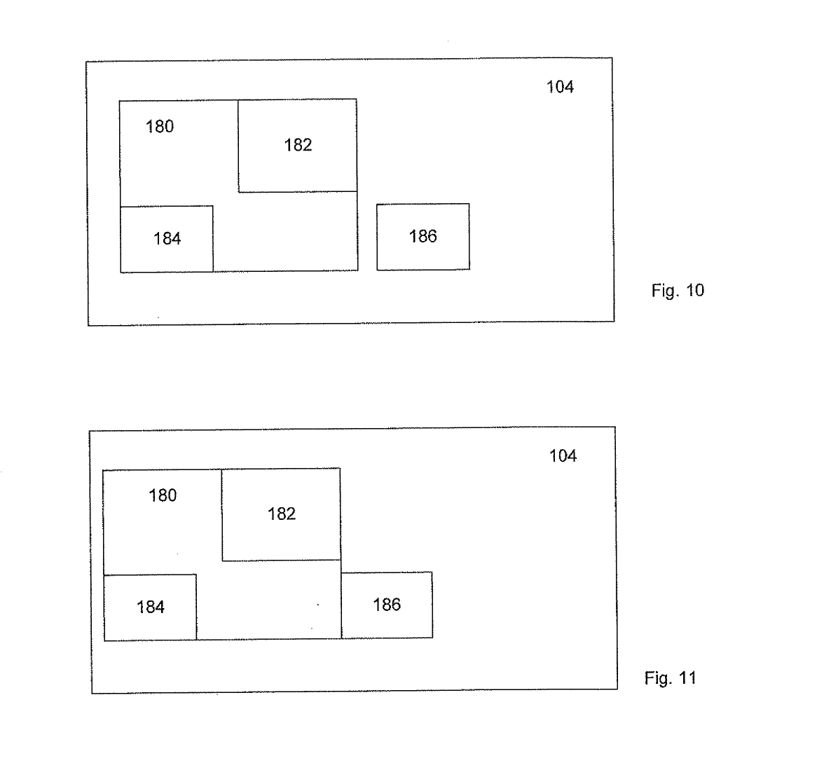

FIG. 10 shows window 180 that encompasses sub-window 182 and sub-window 184. Window 186 is not a sub-window of window 180. FIG. 11 shows an example of the windows after a user generates a command to move window 186 to the left. Window 180 was moved to the left such that it does not overlap with window 186. Sub-window 182 and sub-window 184 were also moved to the left by the same distance as window 180.

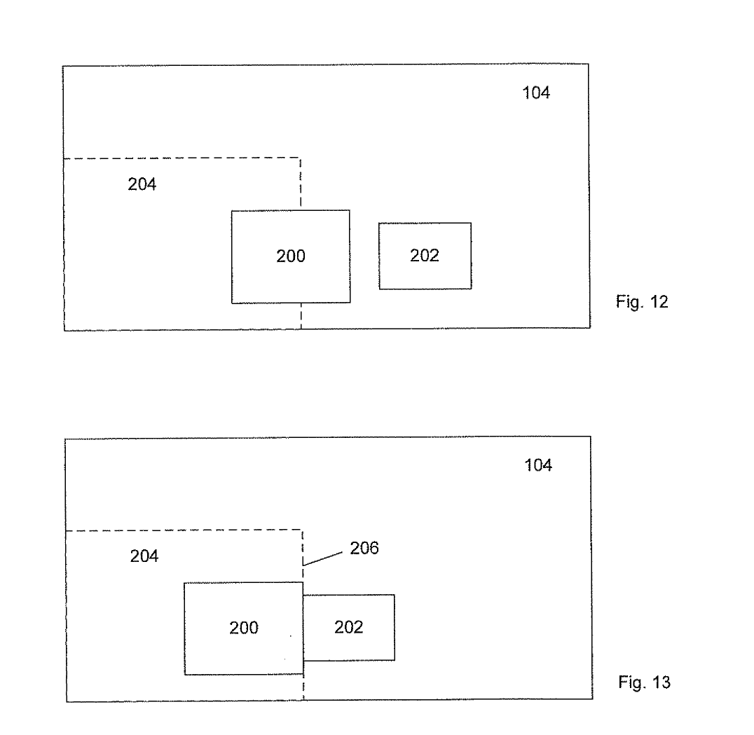

FIG. 12 shows window 200 and window 202. In this example, a restricted area 204 is indicated to the user by dashed lines. Some windows, for example window 202, may not overlap the restricted area 204. Other windows, for example window 200, may overlap the restricted area 204. FIG. 13 shows an example of the windows after a user generates a command to move window 202 to the left such that it completely overlaps window 200. This user command was modified to prevent window 202 from overlapping the restricted area 204. Window 202 was moved to a boundary 206 of the restricted area 204 and window 200 was moved such that it does not overlap with window 202.

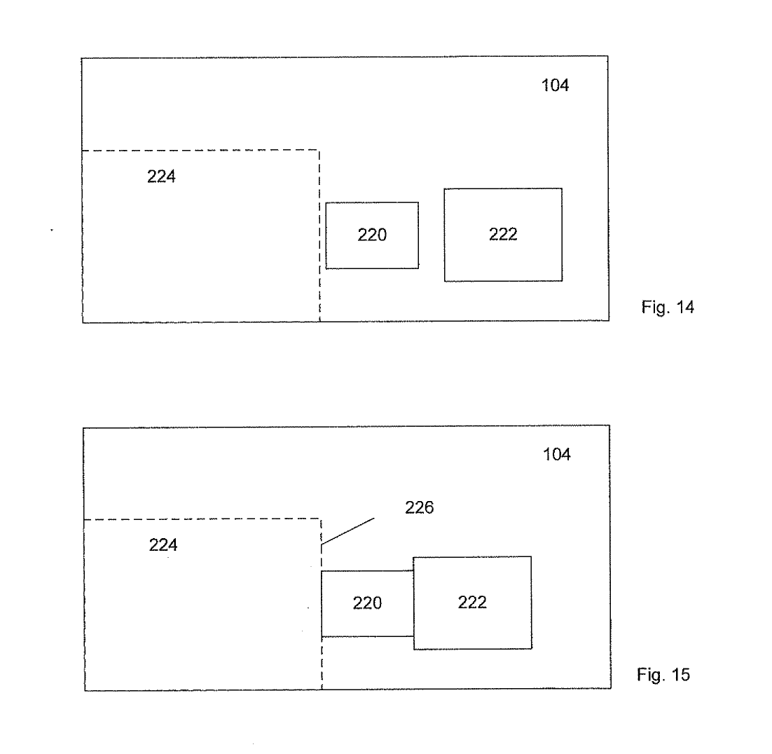

FIG. 14 shows window 220 and window 222. In this example, a restricted area 224 was indicated to the user by dashed lines. Some windows, for example window 220, may not overlap the restricted area 224. FIG. 15 shows an example of the windows after a user generates a command to move window 222 to the left such that it completely overlaps window 220. This user command was modified to prevent window 220 from overlapping the restricted area 224. Window 220 was moved to a boundary 226 of the restricted area 224 and window 222 was moved such that it does not overlap with window 220.

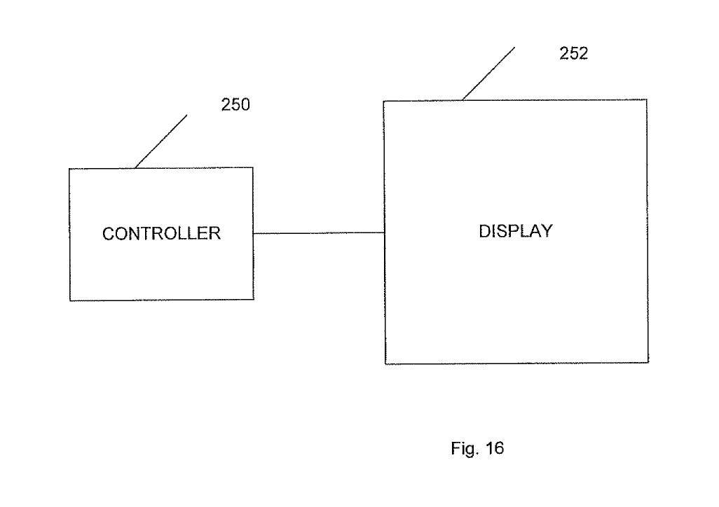

FIG. 16 shows a controller 250 configured to edit a graphical user interface by performing the methods described above. The controller 250 displays windows on a display 252.

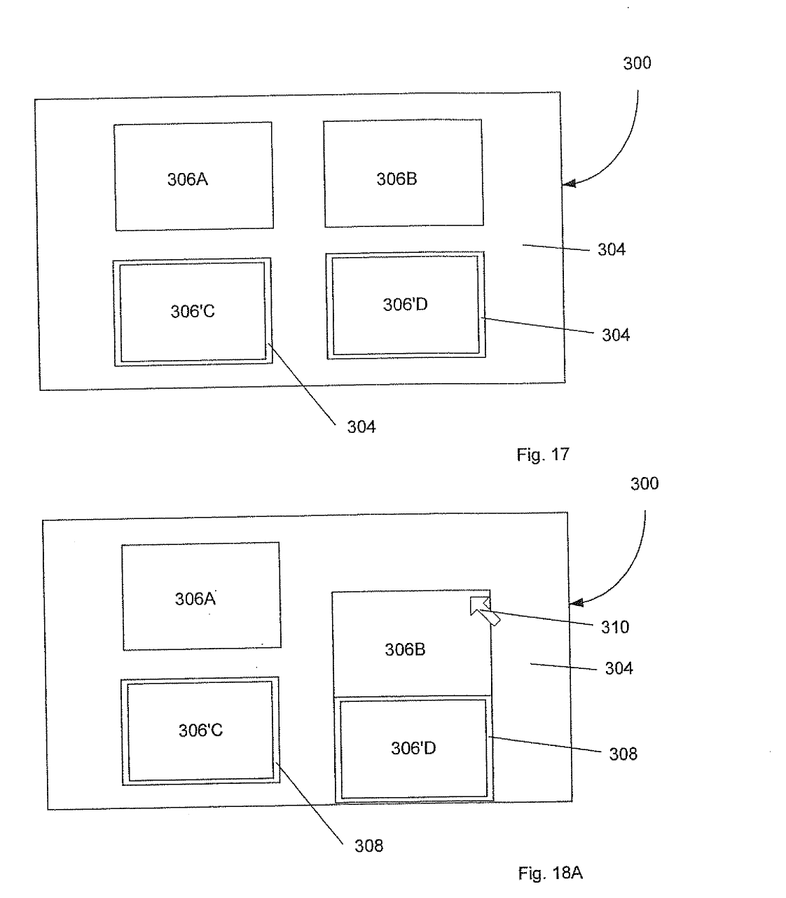

A preferred embodiment of the graphical user interface implemented as part of a medical system is indicated generally as 300 in FIG. 17. As shown in FIG. 17, the graphical user interface comprises a processor (not shown) and a display 304. The display is capable of displaying multiple windows 306A, 306B, 306′C, and 306′D. Each of the windows 306A, 306B, 306′C and 306′D displays the image output of a medical system, including for example a medical imaging system, a medical device navigation system, and ECG system, etc.

For a variety of reasons including regulatory, system design preferences, and system user preferences, there are occasions where one or more of the windows should remain visible on the display at all times. This means that certain windows 306′ should not be overlapped by other windows, which makes it very difficult to rearrange the windows 306 on the display 304. Examples of such windows in this description are identified as 306′, while 306 identifies the windows generically. Windows 306′ may be displayed with a distinctive (in color or appearance) border 308.

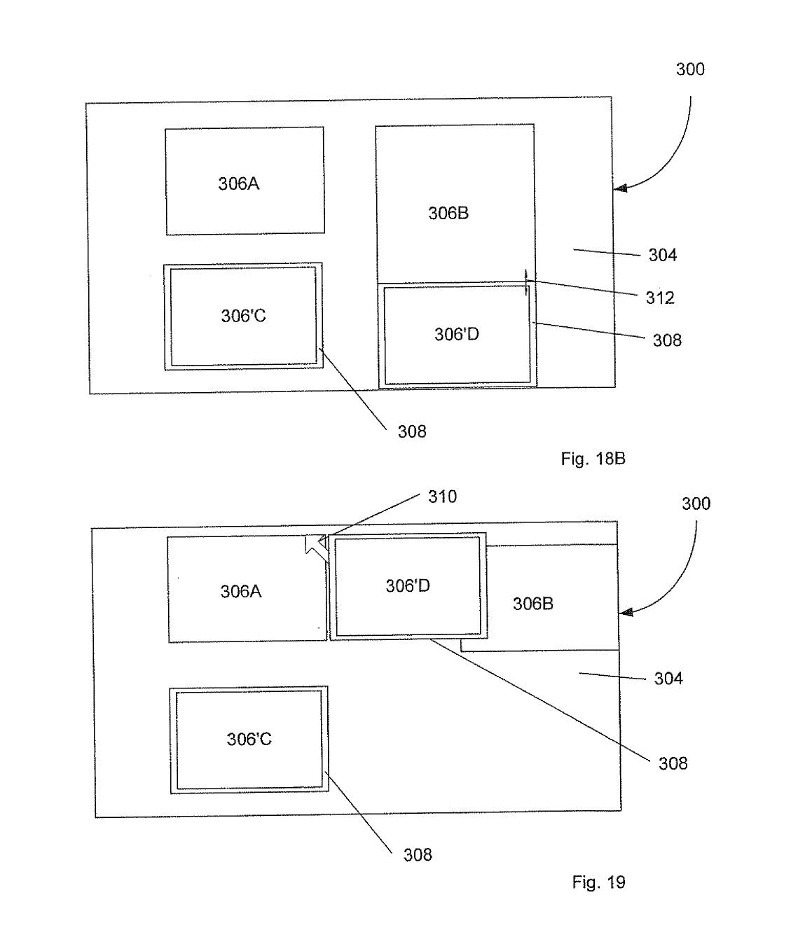

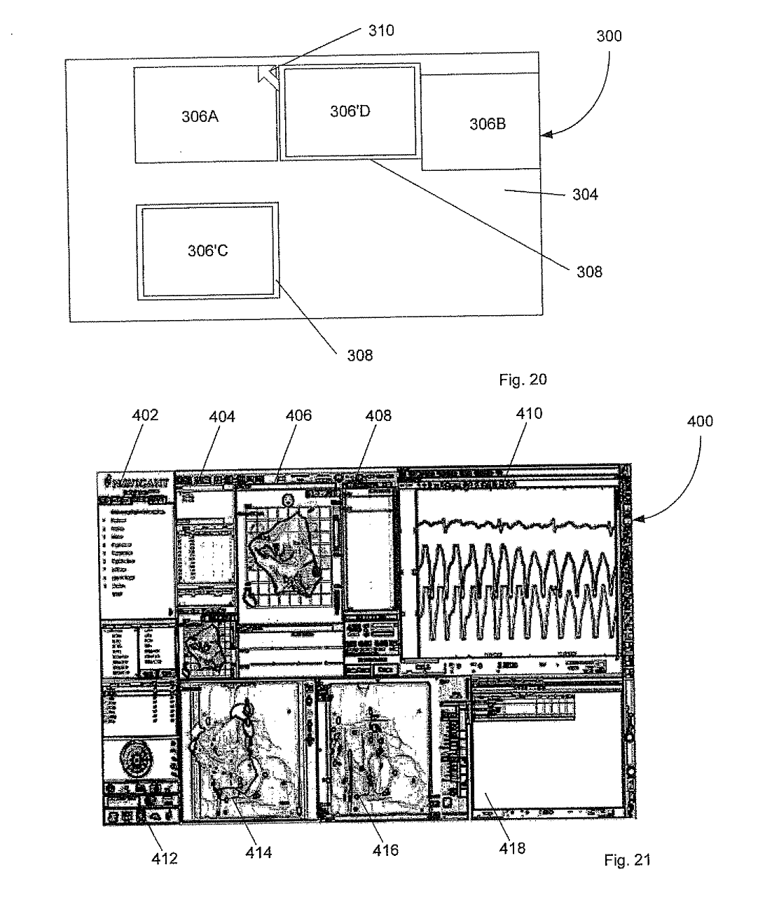

In accordance with the principles of this invention, when a window 306 is moved (for example by clicking and dragging) or expanded (by clicking and dragging a corner or side) on the display 304 and encounters a window 306′ rather than the action being blocked by the boundary of the window 306′, the action is allowed to continue, and the window 306′ is displaced. This is illustrated in FIGS. 18A, where downward movement of window 306B from clicking and dragging it with cursor 310 caused window 306D to be displaced downwardly on the display 304, and in FIG. 18B, where downward expansion of window 306B from clicking and dragging it with cursor 312 caused window 306D to be displaced downwardly on the display 304. The movement or expansion of the window 306 continues until the window 306′ is pushed to the border of the display 304, where further movement is prevented because otherwise part of the window 306′ would not be visible, or the window 306′ encounters another window. When a window 306′ encounters another window, one of several things can happen: In some embodiments, movement of the window 306′ is stopped when it encounters another window. In some embodiments movement of the window 306′ is not stopped by another window 306, but is stopped by another window 306′. When the window 306′ encounters a window 306, it can continue moving by either pushing the window 306 (which may or may not be constrained by the borders of the display 304), overlapping the window 306, or resizing the window 306. In some embodiments movement of the window 306′ is not stopped by encountering either a window 306 or a window 306′. As described above, when the window 306′ encounters a window 306, it can continue moving by either pushing the window 306, overlapping the window 306 (FIG. 19), or resizing the window 306 (FIG. 20); and when the window 306′ encounters another window 306′, it can push the window 306′ just as the moving window 306′ is being pushed.

These same rules of movement of a window 306′ can apply when the window 306′ is moved directly (either by clicking and dragging) or expanded (by clicking and dragging a side) and is not being pushed by another window 306 or 306′.

An image from an actual user interface is shown in FIG. 21 as comprising a display 400, with a medical navigation system window 402, a localization system window 404, a second localization system window 406, an a third localization window 408, a first ECG window 410, a medical navigation system window 412, a first live imaging window 414, and a second imaging window 416, and a second ECG window 418. Some of these widows are conventional windows, but some of these windows are windows that cannot be overlapped, like windows 306′ described above.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method of editing a graphical user interface comprising:
detecting a user command to adjust a first window to at least partially overlap with a second window:
modifying the second window to prevent the overlap; and
adjusting the first window as directed by the user command.

2. The method of claim 1 wherein the modifying comprises moving the second window away from the first window.

3. The method of claim 1 wherein the modifying comprises shrinking the second window by moving a border of the second window away from the first window.

4. The method of claim 1 wherein the modifying comprises shrinking the second window if movement of the second window is constrained.

5. The method of claim 1 wherein the user command is a command to move the first window.

6. The method of claim 1 wherein the user command is a command to resize the first window.

7. The method of claim 1 wherein:
the first window encompasses one or more sub-windows; and
the user command is a command to move one or more of the sub-windows such that the first window expands.

8. The method of claim 1 wherein:
the second window encompasses one or more sub-windows; and
the modifying comprises shrinking the second window by moving one or more of the sub-windows.

9. The method of claim 1 wherein:
the second window encompasses one or more sub-windows; and
the modifying comprises moving the sub-windows.

10. The method of claim 1 wherein the user command is modified to prevent the first window from overlapping a restricted area.

11. The method of claim 1 wherein the user command is modified to prevent the second window from overlapping a restricted area.

12. The method of claim 10 wherein one or more boundaries of the restricted area are indicated to the user.

13. An apparatus comprising:
a display; and
a controller configured to edit a graphical user interface shown on the display;
wherein the controller is configured to:
detecting a user command to adjust a first window to at least partially overlap with a second window;
modifying the second window to prevent the overlap; and
adjusting the first window as directed by the user command.

14. The apparatus of claim 13 wherein the modifying comprises moving the second window away from the first window.

15. The apparatus of claim 13 wherein the modifying comprises shrinking the second window by moving a border of the second window away from the first window.

16. The apparatus of claim 13 wherein the modifying comprises shrinking the second window if movement of the second window is constrained.

17. The apparatus of claim 13 wherein the user command is a command to move the first window.

18. The apparatus of claim 13 wherein the user command is a command to resize the first window.

19. The apparatus of claim 13 wherein:
the first window encompasses one or more sub-windows; and
the user command is a command to move one or more of the sub-windows such that the first window expands.

20. The apparatus of claim 13 wherein:
the second window encompasses one or more sub-windows; and
the modifying comprises shrinking the second window by moving one or more of the sub-windows.

21. The apparatus of claim 13 wherein:
the second window encompasses one or more sub-windows; and
the modifying comprises moving the sub-windows.

22. The apparatus of claim 13 wherein the controller is further configured to modify the user command to prevent the first window from overlapping a restricted area.

23. The apparatus of claim 13 wherein the user command is modified to prevent the second window from overlapping a restricted area.

24. The apparatus of claim 22 wherein one or more boundaries of the restricted area are indicated to the user.

25. The method of claim 11 wherein one or more boundaries of the restricted area are indicated to the user.

26. The apparatus of claim 23 wherein one or more boundaries of the restricted area are indicated to the user.
